(19) United States
(12) Patent Application Publication
(10) Pub. No.: US 2023/0245118 A1
(43) Pub. Date: Aug. 3, 2023

(54) POINT-TO-POINT (P2P)-BASED DATA PROCESSING METHOD AND SYSTEM, COMPUTING DEVICE, AND STORAGE MEDIUM

(71) Applicant: FIFTH FORCE TECHNOLOGY LIMITED, Hong Kong (HK)

(72) Inventor: Weisha Zhu, Beijing (CN)

(21) Appl. No.: 18/129,088

(22) Filed: Mar. 31, 2023

Related U.S. Application Data
(63) Continuation-in-part of application No. PCT/CN2022/127491, filed on Oct. 25, 2022.

(30) Foreign Application Priority Data
Jan. 14, 2022 (CN) 202210046337.0

(51) Int. Cl. G06Q 20/38; G06F 16/23; G06F 16/22; G06Q 20/40

(52) U.S. Cl. CPC G06Q 20/389; G06F 16/2379; G06F 16/2255; G06Q 20/401

(57) ABSTRACT

Disclosed are a point-to-point (P2P)-based data processing method and system, a computing device, and a storage medium. In the P2P-based data processing method, a general ledger and all subledgers are associated by using a hash index. When a transaction operation of a subledger is triggered, transaction legality of the subledger is verified by using the general ledger, and for a legal transaction, an amount of the subledger and an amount of the general ledger are updated, the general ledger and the subledger are enabled to save a current transaction record, and the general ledger is enabled to update a hash index table. The general ledger only stores a latest transaction entry and a corresponding hash index of the subledger, while a transaction-specific running tally is stored in the subledger for a user to manage, so as to realize a unique distributed account book structure of P2P payment.

### CROSS REFERENCE TO RELATED APPLICATIONS

The present application is a Continuation-In-Part Application of PCT Application No. PCT/CN2022/127491 filed on Oct. 25, 2022, which claims the benefit of Chinese Patent Application No. 202210046337.0 filed on Jan. 14, 2022. All the above are hereby incorporated by reference in their entirety.

### TECHNICAL FIELD

The present disclosure relates to the technical field of data processing, and in particular, to a point-to-point (P2P)-based data processing method and system, a computing device, and a storage medium.

### BACKGROUND

A current data processing method of centralized payments such as a card payment (deposit card or credit card), an Alipay payment, and a WeChat payment has high transaction efficiency and security, but low transparency and autonomy. A data processing method of a P2P payment combined with a blockchain is characterized by high security, high transparency, and high autonomy, but has low transaction efficiency and is not conducive to personal privacy protection. Therefore, current payment data processing methods cannot ensure both security and efficiency of payment data processing.

### SUMMARY

Based on this, it is necessary to provide a P2P-based data processing method and system, a computing device, and a storage medium based on a problem that an existing payment method cannot ensure both security and efficiency of payment data processing.

According to a first aspect, an embodiment of the present disclosure provides a P2P-based data processing method, including:

when a transaction operation of a subledger is triggered, verifying transaction legality of the subledger by using a general ledger; and

for a legal transaction, updating an amount of the subledger and a corresponding amount of the general ledger, enabling the subledger to save a current transaction record, and enabling the general ledger to generate a latest transaction entry of the subledger and update a hash index table; where

the legal transaction means that transaction data has a legal source and is correct;

the hash index table is configured to record a correspondence between a hash value of a latest transaction record of the subledger and an address of the subledger; and

the general ledger is provided with a plurality of registers, each register stores one type of asset, and an amount of the asset is equal to a sum of amounts of the asset in latest transaction records of all subledgers in the general ledger.

Optionally, the transaction operation includes an internal transaction operation between any two subledgers, and an external transaction operation between any subledger and an external account; and an interaction between any subledger and the general ledger is encrypted.

Optionally, when the transaction operation is the internal transaction operation, following operations are performed:

forwarding a transaction request reported by a first subledger to the general ledger, where the transaction request carries an asset type, an asset amount, and an address of a second subledger;

enabling the general ledger to verify transaction legality of the first subledger based on the transaction request;

for a legal transaction, keeping an amount of an asset in a register of the general ledger unchanged, and enabling the general ledger to generate new transaction entries of the first subledger and the second subledger; and

when two parties of the transaction confirm the transaction, updating the hash index table based on the transaction entries of the first subledger and the second subledger, and completing the transaction.

Optionally, when the transaction operation is the external transaction operation and an operation type is transfer-out, following operations are performed:

forwarding a transaction request reported by the subledger to the general ledger, where the transaction request carries an asset type, an asset amount, and an address of the external account;

enabling the general ledger to verify transaction legality of the subledger based on the transaction request; and

for a legal transaction, enabling the general ledger to generate a new subledger transaction entry, and when two parties of the transaction confirm the transaction, deducting, based on the new subledger transaction entry, an amount corresponding to the asset type in the register, and after verifying that an amount corresponding to the asset type in the register of the general ledger is equal to a sum of amounts corresponding to the asset type in latest transaction records of all subledgers in a latest transaction entry of the general ledger, updating the hash index table and completing the transaction.

Optionally, when the transaction operation is the external transaction operation and an operation type is transfer-in, following operations are performed:

enabling the general ledger to confirm an asset type and amount of a current transaction based on addresses of the subledger and the external account that are reported by the subledger, obtaining the asset type and amount in the address of the external account and transferring the obtained asset type and amount to the register, such that an asset amount of the register increases, generating a new subledger transaction entry and pushing the new subledger transaction entry to the subledger, updating the hash index table based on the new subledger transaction entry, and completing the transaction.

Optionally, after the verifying transaction legality of the subledger by using a general ledger, the P2P-based data processing method further includes:

enabling the general ledger to obtain execution program code of the current transaction, and sending the execution program code to an audit node authorized by the subledger to verify a hash value of the execution program code.

Optionally, before the transaction operation of the subledger is triggered, the P2P-based data processing method further includes:

storing a transaction-specific asset type and amount of the subledger by using a plurality of temporary deposit accounts defined for the subledger in the general ledger, so as to divide one transaction into a plurality of transactions.

According to a second aspect, an embodiment of the present disclosure provides a P2P-based data processing system, including:

a verification module configured to: when a transaction operation of a subledger is triggered, verify transaction legality of the subledger by using a general ledger;

a payment module configured to: for a legal transaction, update an amount of the subledger and a corresponding amount of the general ledger; and

a storage module configured to enable the subledger to save a current transaction record, and enable the general ledger to generate a latest transaction entry of the subledger and update a hash index table; where

the legal transaction means that transaction data has a legal source and is correct;

the hash index table is configured to record a correspondence between a hash value of a latest transaction record of the subledger and an address of the subledger; and

the general ledger is provided with a plurality of registers, each register stores one type of asset, and an amount of the asset is equal to a sum of amounts of the asset in latest transaction records of all subledgers in the general ledger.

According to a third aspect, an embodiment of the present disclosure provides a computing device, including a memory, a processor, and a computer program stored in the memory and executable on the processor, where the processor executes the computer program to implement the steps included in the above-described P2P-based data processing method.

According to a fourth aspect, an embodiment of the present disclosure provides a storage medium, where the storage medium stores a computer-executable instruction, and the computer-executable instruction is configured to enable a computer to perform the steps included in the above-described P2P-based data processing method.

One of the foregoing technical solutions has following beneficial effects:

The embodiments of the present disclosure provide a P2P-based data processing method and system, a computing device, and a storage medium. In the P2P-based data processing method, a general ledger and all subledgers are associated by using a hash index. When a transaction operation of a subledger is triggered, transaction legality of the subledger is verified by using the general ledger, and for a legal transaction, an amount of the subledger and an amount of the general ledger are updated, the general ledger and the subledger are enabled to save a current transaction record, and the general ledger is enabled to update a hash index table. Based on this, the general ledger only stores a latest transaction entry and a corresponding hash index of the subledger, and does not store a transaction-specific running tally of the subledger, while the transaction-specific running tally is stored in the subledger for a user to manage, so as to realize a unique distributed account book structure of a P2P payment. This not only achieves centralized transaction efficiency, but also has characteristics of a blockchain account book, which can improve security of payment data processing, and achieve high efficiency of the payment data processing.

### BRIEF DESCRIPTION OF THE DRAWINGS

A more detailed description of exemplary embodiments of the present disclosure in the accompanying drawings makes the above and other objectives, features, and advantages of the present disclosure more obvious. The same reference numerals in all the accompanying drawings indicate the same parts. The following accompanying drawings are not intentionally scaled to an actual size in an equal proportion, and the emphasis is to illustrate the gist of the present disclosure.

FIG. 1 is a schematic structural diagram of an entry of a subledger in a general ledger according to an embodiment of the present disclosure;

FIG. 2 is a schematic structural diagram of an index of a subledger in a general ledger according to an embodiment of the present disclosure;

FIG. 3 is a schematic structural diagram of a general ledger according to an embodiment of the present disclosure;

FIG. 4 is a schematic flowchart of a P2P-based data processing method according to an embodiment of the present disclosure;

FIG. 5 is a schematic flowchart of transferring out a crypto-asset by an individual according to an embodiment of the present disclosure;

FIG. 6 is a schematic diagram of transferring in a crypto-asset by an individual according to an embodiment of the present disclosure;

FIG. 7 is a schematic flowchart of verifying transfer-out of a crypto-asset according to an embodiment of the present disclosure;

FIG. 8 is a schematic flowchart of a P2P-based data processing method according to an embodiment of the present disclosure;

FIG. 9 is a schematic flowchart of a P2P-based data processing method according to an embodiment of the present disclosure;

FIG. 10 is a schematic flowchart of a P2P-based data processing method according to an

FIG. 11 is a schematic structural diagram of a P2P-based data processing system according to an embodiment of the present disclosure;

FIG. 12 is a schematic structural diagram of a P2P-based data processing system according to an embodiment of the present disclosure;

FIG. 13 is a schematic structural diagram of a computing device according to an embodiment of the present disclosure; and

FIG. 14 is another schematic structural diagram of a computing device according to an embodiment of the present disclosure.

### DETAILED DESCRIPTION

To facilitate the understanding of the present disclosure, the present disclosure will be described more completely below with reference to the related accompanying drawings. Preferred embodiments of the present disclosure are shown in the accompanying drawings. However, the present disclosure may be embodied in various forms without being limited to the embodiments described herein. On the contrary, these embodiments are provided to make the present disclosure more thorough and comprehensive.

It should be noted that when a component is considered to be “connected” to another component, the component may be directly connected to the another component and integrated with the another component, or there may be an intermediate component. The terms “setting”, “an end”, “another end”, and similar expressions used in this specification are used for illustrative purposes only.

Unless otherwise defined, all technical and scientific terms used herein have the same meaning as commonly understood by those skilled in the technical field of the present disclosure. The terms used in the specification of the present application are merely for the purpose of describing specific embodiments, rather than to limit the present disclosure. The term “and/or” used herein includes any and all combinations of one or more of the associated listed items.

In order to facilitate the understanding by those skilled in the art, some technical terms involved in this specification are described below:

1. P2P means that during payment data processing, a payer and a counterparty do not have to disclose their real identities, thereby ensuring anonymity. For a centralized system, all data cannot be controlled personally.

2. A general ledger is constituted by an asset register, a latest transaction record of a subledger, a hash index table of the subledger, a register table, a calling record log, a transaction log ledger, a verification log record, and the like. The general ledger is conceptually different from traditional financial general ledger, but is similar to a blockchain account book of a crypto-as set.

3. The subledger has functions of a public key and a private key of the blockchain account book. Different from the blockchain account book, the subledger has an account book and has a reconciliation relationship with the general ledger.

In any embodiment of the present disclosure, a user can manage his/her own account book. In the embodiments of present disclosure, a security level can be specified by the user by using a multi-signature and multi-backup account book of a cloud product (for example, home cloud), such that the security level can exceed a security level of a bank. With transfer control of the general ledger, the user can really manage his/her own account book.

Machine credit can be guaranteed only by combining openness and security. The openness is to make people believe, and the security ensures correctness of data. A blockchain security technology is characterized by encrypted transmission, public/private key authentication, confirmation of untampered data by using hash and signature algorithms, access control, multi-signature, combined signature, hash confirmation, verifiability, and multi-backup, which are all realized in this system.

The embodiments of the present disclosure are combined with a cloud product to achieve excitation and capital autonomy. An encryption technology is used to improve the centralized system to make it conform to current specifications of the crypto-asset, actually conform to specifications of Web3.0. From a perspective of a blockchain and a directed acyclic graph—based account book technology that are widely used for the crypto-asset at present, it is impossible for any scheme to exceed the centralized system in terms of transactions per second (TPS). The Internet can be promoted to Web3.0 only by reforming the existing centralized system.

To achieve the above objective, the embodiments of the present disclosure face and overcome following problems:

1. An asset has a source.

An asset defined in a P2P payment system must be a consensual asset and have a source.

There are two changes during the development of a digital asset in the prior art. One change is that a mature mode is formed for the asset, and the other change is that a bookkeeping speed is far lower than that of a centralized payment system. The TPS of the crypto-asset has a different meaning from that of a centralized payment. No matter how fast the TPS described in open data is, in a specific two-person payment, there is a magnitude difference from the TPS of the centralized payment. However, when the asset is the source, the system in the present disclosure can achieve a transaction payment level measured by the TPS of the centralized payment, such that the user feels no obvious speed difference between the traditional centralized system and a chainless system.

2. No blockchain is required for bookkeeping.

At present, a mining cost of blockchain-based bookkeeping is very high, while a bookkeeping cost in a specific implementation of the present disclosure is low. At present, a blockchain participant still uses the blockchain to complete a P2P payment. The embodiments of the present disclosure abandon the blockchain but realize Web3.0 by indexing the general ledger.

3. Redundancy and waste of blockchain account books are avoided.

For a financial application, six backups are enough for backup redundancy. It is unnecessary to have more backups. The general ledger in the embodiments of the present disclosure can be backed up by the user in real time. From a perspective of the crypto-asset, the general ledger supports concepts of openness and transparency, but does not support an unrelated transaction party to participate in operation. Because no asset is generated in the embodiments of the present disclosure, a party unrelated to a current transaction does not need to participate in bookkeeping. Accounting logic ensures accuracy of the account book. A transaction is an act between two parties and only needs to be accepted by the two parties. An external transfer is more complicated. A private key of a host is specified by a transaction originator, that is, a transfer-out party specifies multi-signature members, and the transaction originator may specify a plurality of signers and a specific quantity of signers. If an amount of a to-be-transferred asset is not large, the multi-signature private key may alternatively be specified by the system.

4. Machine-based bookkeeping and modification are realized, and a credit rating of a machine is reached.

An application process of the embodiments of the present disclosure is reliable, and the machine takes the place of human being. In this way, only the machine has a right of modification. However, after a transaction result is generated, the machine cannot modify a log ledger.

5. No account book is available for the general ledger.

A ledger kept by the user is referred to as the subledger. The user operates his/her own ledger. The subledger is a transaction-specific running tally of the user. The general ledger is public, and is managed by the machine.

6. A decentralized account book is designed.

Because only the machine has the right of modification, the general ledger may be referred to as a machine general ledger. The subledger and the general ledger constitute a distributed account book. A personal account book is possessed by an individual, and a personal transaction is carried out by the individual. Two parties of the transaction should check the transaction. In this case, the system does not participate in the transaction. In a whole network, only the general ledger and participants, namely, at least three parties, are affected. The general ledger allows multi-party operations, but it is also difficult to ensure that there is no waiting, and stack waiting needs to be designed. The general ledger includes a latest change ledger of the subledger, namely, a latest record. This record is the same as a latest record of the subledger. A latest transaction index of the general ledger and the latest record of the subledger are in a check relationship. The subledger and the general ledger store different content. Such distributed computing and distributed storage are more in line with definitions of distributed computing and distributed storage in the computer industry. The system performs, in a P2P manner, synchronous update on a node that downloads a complete account book. To avoid an error, only one cluster in the system serves as an original computing node, and the rest are backup nodes.

The general ledger (account) in the embodiments of the present disclosure has following functions:

1. Index function.

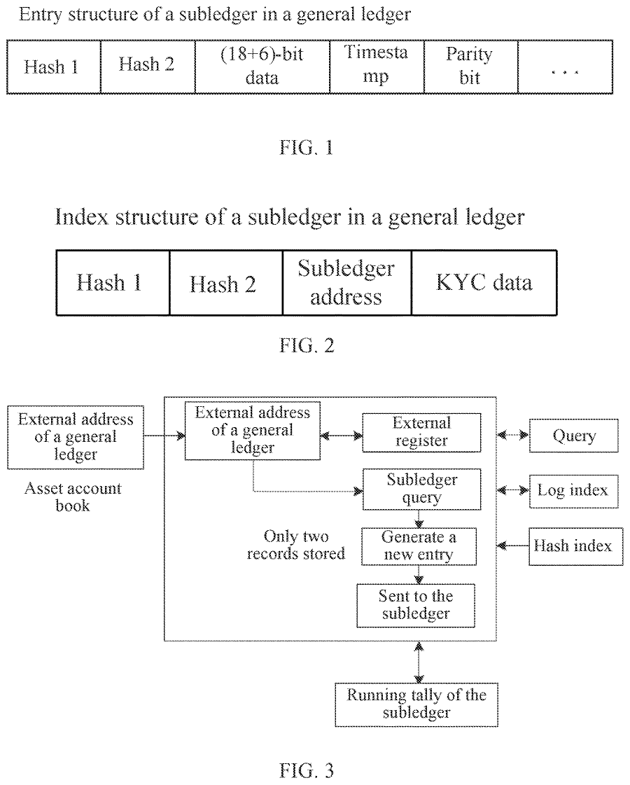

As shown in FIG. 1 and FIG. 2, FIG. 1 is a schematic structural diagram of an entry of the subledger in the general ledger according to an embodiment of the present disclosure, and FIG. 2 is a schematic structural diagram of an index of the subledger in the general ledger according to an embodiment of the present disclosure.

The general ledger does not include a transaction-specific running tally of the subledger, and therefore, can be queried by anyone like a crypto-as set account book. Anyone can only query a latest transaction record of the subledger. If the general ledger does not synchronize all transaction log ledgers of the subledger, no historical transaction record of the subledger can be found. Even if all transaction records are synchronized, whether the subledger can be queried depends entirely on a setting of the subledger. Moreover, even if the transaction records are public, they cannot be understood by people other than the user, and the user can only check his/her own transaction record. The general ledger only stores a latest transaction entry and a hash index, while a running tally of the transaction entry is stored in a personal subledger and saved by the user. This realizes a unique distributed account book structure of a P2P payment, which achieves centralized transaction efficiency and has characteristics of a blockchain account book, thereby making Web3.0 based on a blockchain idea practical.

The general ledger is divided into a data region and a program region. Data and programs are stored separately, and a hash value of a key transfer program is saved. Before the transfer program is called, the hash value of the program is checked to ensure that the program is not tampered with.

2. Exchange between the general ledger and an external account.

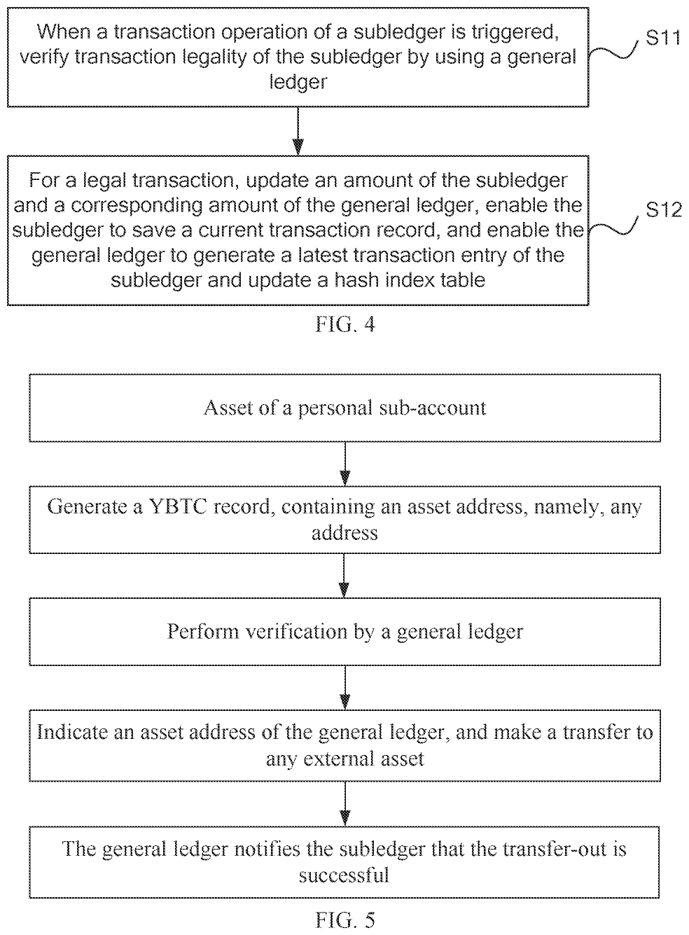

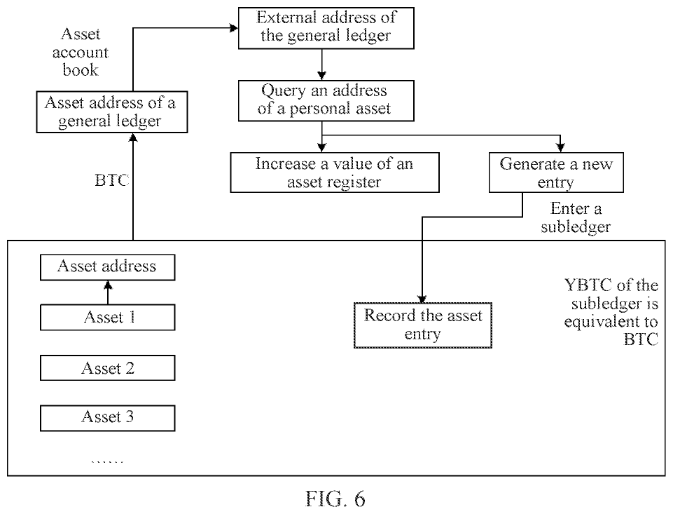

As shown in FIG. 3, FIG. 3 is a schematic structural diagram of the general ledger according to an embodiment of the present disclosure.

An external address is the same as an address of the general ledger, which is required for an input and an output.

A same asset can be transferred in only when the subledger has an “external address”. Transfer-in operations performed by others is invalid. A return function is designed after the transfer-in operation.

It is valid only when the subledger initiates an external transfer.

The general ledger can be queried, but a directory index and the hash index cannot be queried for the sake of privacy. The log ledger can be downloaded. However, whether each transaction record can be queried depends on an encryption setting of a related party. Only the related party can decrypt his/her transaction record.

The hash index has an address of the subledger, Know Your Customer (KYC) data, and other data.

The system is provided with an external interactive register group, which is referred to as an external register for short. External account data is quickly transferred to the personal subledger after being imported into the system by using the external register, and an asset amount of the external register increases accordingly. For the crypto-as set, addresses of external personal data and internal personal data are authenticated by using a public key, and a standard data structure of an application programming interface (API) is provided for different types of assets. The bank must follow this standard data structure during conversion. At present, an ERC20 format is used, just like Tether USD (USDT) of a stable asset.

The register itself is stored in the data region and is separated from an account data region of the general ledger. Each register has its own data structure and its own hash value. For the sake of clarity, a principle of “one asset one address” is followed.

In fact, data exchange between the system and any external account can be completed, provided that an address is inserted into the external account. There is no manual intervention herein. When no external transfer occurs, data of the register is constant. The asset amount of the external register for a same asset type is a sum of amounts of the same asset type in all subledgers in a record of the general ledger.

When an asset is transferred out, a corresponding amount is subtracted from a total asset amount of the external register of the general ledger. In this operation, that the register receives a transfer-out record is taken as a condition, and a program of the external register enters a verification program after verifying that the transfer-out record is correct. The transfer-out record is saved in a log of an asset register outside the data region.

3. Verification function.

Verification is intended to ensure credibility of a calculation process. A third-party machine is introduced for the verification, and a transaction result is confirmed by the transaction parties and the machine. A verification result is temporarily stored in an index ledger of the general ledger and permanently stored in the subledger.

3.1. Verifying correctness of an external transfer account: The asset is ensured to have a source. The blockchain concept of the crypto-asset is used to calculate a hash value of each transaction record. The general ledger stores hash values included in a current record and a previous record. One record includes a hash value of a previous record and a hash value after the record is completed. For example, when a crypto-asset is sent to the system, the crypto-asset is stored in a crypto-asset register. There are also two hash positions in the register, and one of the hash positions is empty. Only the register may have the empty position. When the register receives external data, the register is set to store the same data as that of an address of the external crypto-as set. In this case, a hash value of a current record can be calculated and is stored in a second hash position of the current record. When data of the register is transferred to a corresponding customer, the customer verifies the hash value in the register. A first hash position is empty, indicating the external data. The customer verifies the hash value in the second hash position to determine whether the record is correct. If the record is correct, the general ledger accepts the record, and calculates a harsh value of the record.

3.2. Verifying whether a common transaction is correct: When the customer performs a transfer again, a next customer verifies a hash value of a corresponding transfer record to verify whether account data is correct. A verification process of the transfer and a position of the hash value are shown in Table 1. For the “Current record”, hash 2 indicates a source of a previous record, and hash 3 indicates a hash value of the record. When hash 3 does not match a hash value of a verification transaction record, the program returns.

TABLE 1
Hash positions in the verification process before the transfer

| | | | |
|---|---|---|---|
| Previous record: | Hash 1 | Hash 2 | Data . . . |
| Current record: | Hash 2 | Hash 3 | Data . . . |
| | Transfer completed | ↓ | |
| Next record: | Hash X | Hash X + 1 | Data . . . |

Assuming that data is being sent for the “Current record”, after the transfer is completed, data in Table 2 is available.

TABLE 2
Hash position change in the verification process after the transfer

| | | | |
|---|---|---|---|
| Current record: | Hash 3 | Hash 4 | Data . . . |
| | Transfer completed | ↓ | |
| Next record: | Hash 4 | Hash 5 | Data . . . |

It can be seen that the hash value of the first hash position is the data source, and the hash value of the second hash position is used to ensure that the data is correct. The machine performs a check finally to confirm whether the transaction is correct. If the transaction is correct, the “Previous record” is deleted to ensure that all data is sourced. It can be ensured that the data is correct, provided that the machine verifies that hashes of two sent and received records in Table 2 are correct. One subledger has at most one record in the general ledger. Sent and received data stored in the general ledger is used for verification. A contact core of the blockchain is a “previous block”. In the embodiments of the present disclosure, a concept of the “previous record” is used. If the blockchain can be recognized, a data chain should also be recognized. The general ledger is not afraid to be exposed, because a real account book is personally possessed. The above process can avoid a “double-spending” transaction.

3.3. Verifying whether a total quantity of account books of the general ledger is consistent with that of account books of the subledger: A result of adding up latest data of the subledger in the general ledger is compared with asset data of the register, and the two values should be the same in a normal case. The verification is performed once before the transaction to ensure correct values, and is performed again after the transaction. For an external sending operation, it is necessary to change the asset amount of the external register first, and then calculate the total asset amount. If a verification result is correct, an external sending program is executed. The external sending program has public and private key verification. The user can control one verification machine in a computing cluster through multi-signature. The verification process is concurrent. The asset amount of the register changes only after the verification is passed.

A subledger transaction book is stored in each subledger. The general ledger cannot obtain the subledger transaction book unless the general ledger obtains approval from a subledger owner. A function of obtaining the subledger transaction book is disabled by default.

A hash value of subledger program code itself is constant, which is used to verify a new copy. For a same version number, a hash value of a program is constant. The code changes after version upgrade. In order to ensure accuracy, the customer must upgrade the code before performing new operation. The program and the data are separated. The program code is verified to ensure that there is no hacker plug-in and that the program code before and after running is correct.

4. Anonymization function.

Anonymization is a major characteristic of the crypto-asset and belongs to privacy protection. The general ledger does not know a counterparty of the transaction. A consumption of storage is reduced for the crypto-asset by using a Merkel tree. Compared with the crypto-asset account book, the general ledger in the embodiments of the present disclosure is more economical. The subledger can retain all its own transactions, and a distributed account book is really realized, which is impossible for the crypto-asset. Like the crypto-asset, the anonymization in the embodiments of the present disclosure is also limited. Because there is an IP address associated, complete anonymization cannot be achieved for public power. In addition, the system may further include a user transient memory. One user can define a plurality of transient memories arbitrarily. In the system, 10 transient registers are preset to mainly avoid dilation of the general ledger. The transient memory is designed for the customer to disperse a large quantity of account books and then send dispersed account books. Small data can also be sent. When two transfers are performed, a real big account is hidden. Only one record of the subledger in the general ledger records a hash value associated with a previous record, so a counterparty cannot guess how many account books there are in your account. There is a hidden-transfer setting in the subledger. Based on this setting, two transfers are performed automatically, and data, of the subledger, displayed on the general ledger is not exposed.

5. Query function: including general ledger query and subledger query.

Both the general ledger and the program code are public. Only a private key of the general ledger is not public. The private key of the general ledger is divided into three levels. At a highest level, the private key is generated instantly during a transfer. This is a conflict between a speed and security. A specific decision is made by the user. If a large amount is transferred, the speed can be sacrificed to a certain extent to ensure transaction security.

5.1 General ledger query including: A. external register query. A total quantity of assets of any type in the system can be obtained by querying the external register. B. Query of any account name and address. A username corresponds to an address. C. Query of a latest transaction record of any current subledger. (Note: The query is allowed only when an owner of the subledger allows the general ledger to query his/her subledger, or when an owner of the subledger discloses his/her subledger information. Whether the query is allowed is determined by the owner of the subledger.) D. Statistical data query, including a total volume and quantity of transactions by asset category, a volume and quantity of transactions by year, month and day, and charts.

5.2 Subledger query, including: A. an account name of a specific subledger and a correspondence between an internal account and an external address of each type of asset; B. a contact way of making the subledger public; C. statistical query, which is similar to account book query; and D. a right of making the subledger public, which is possessed by the subledger and is set in a setting function.

6. Storage function, including storage of the general ledger and storage of the subledger.

6.1: Storage of the general ledger. The general ledger is a cluster, which is designed in a same manner as an underlying layer of a centralized cluster. The general ledger adopts a three-host peer-to-peer design, with a total of 6 copies that are synchronized in real time. The whole program is not provided with a running tally of the subledger. In essence, the general ledger is a calculator. The running tally is in the subledger and is updated when being used. The general ledger also has an optional subledger backup function, but this function needs to be set by a subledger user and a corresponding fee needs to be paid. In addition, there is a multi-signature and multi-backup account book corresponding to the present disclosure. A security level of the multi-signature and multi-backup account book is higher than that of a cold account book, and a cost is lower than that of backup through a general ledger system.

6.2. Encryption of the multi-signature and multi-backup account book. This function is designed for a cloud product in the embodiments of the present disclosure. The cloud product has an advanced voice recognition function. A password of the account book and an address of the crypto-asset are stored in a password box. A payment in the system may be completed by using a voice, a fingerprint, or a combination of a voice and a fingerprint. Generally, it is not difficult to form three backups for one user. Three cloud product nodes can be used to form another three backups. Synchronization is performed automatically after the payment is completed. After the synchronization is completed, the backups are displayed on a master node selected by the user. It is safest for the user to control his/her own data. This method also resolves a biggest pain point of the encryption, namely, the loss problem.

7. Notification function.

A notice is sent to a receiver by using an SMS message or by using an email, and a transaction success notice is sent to a sender.

8. Alarm function.

The alarm function reports an alarm separately for abnormal program operation, an illegal login, a sending failure, a timeout, and a device hardware error.

9. Message function.

The system includes a community, and there is a bulletin board and private information for system customers to communicate with each other.

The system in the embodiments of the present disclosure is a distributed system that conforms to the computer industry, and is also a P2P payment system with machine credit. A payment speed of the system is basically the same as that of the centralized system. The system is not limited to an asset payment, and is also an effective payment tool for an electronic ticket.

In view of this, the embodiments of the present disclosure provide a P2P-based data processing method and system, a computing device, and a storage medium. In the P2P-based data processing method, a general ledger and a subledger are associated by using a hash index. When a transaction operation of the subledger is triggered, transaction legality of the subledger is verified by using the general ledger, and for a legal transaction, an amount of the subledger and an amount of the general ledger are updated, the subledger is enabled to save a current transaction record, and the general ledger is enabled to update a hash index table. Based on this, the general ledger has no running tally of transaction data. The general ledger does not query a historical transaction record of the subledger, but only stores the index table, while the running tally of the transaction data is permanently stored in the subledger, so as to achieve account book decentralization, high transaction efficiency, and high account autonomy, and protect personal privacy data in the P2P payment. The system not only has an advantage of a fast transaction of the centralized system, but also avoids centralized third-party control. The individual can control the whole transaction by controlling a multi-signature private key of a server. This is to transform the centralized payment system based on the idea of the blockchain. In this way, the centralized system is upgraded to a Web3.0 system.

As defined in Web3.0, data sovereignty belongs to people, data is transparent and credible, and everybody contributes a resource, everybody shares a benefit, and everybody participates in governance.

The system in the embodiments of the present disclosure is located hereupon, and the account book is personally possessed. The general ledger storing 2 billion account entries, with a capacity not exceeding 2 T, has a low operating cost. It does not cost much to use flash drivers to make the speed higher than that of the centralized system. Data movement is personally controlled, the data is transparent and traceable, and community governance is introduced. From a perspective of security, there is a 51% attack on the crypto-asset, while there is no 51% attack on the asset in the embodiments of the present disclosure.

In order to better understand the technical solutions provided in the embodiments of the present disclosure, application scenarios applicable to the technical solutions provided in the embodiments of the present disclosure are briefly described below. It should be noted that the application scenarios described below are only used to illustrate the embodiments of the present disclosure, and are not intended to limit the present disclosure. In specific implementation, the technical solutions provided in the embodiments of the present disclosure can be flexibly applied based on an actual need.

In an application scenario, the general ledger corresponds to one computer system (such as a computer cluster), one subledger corresponds to one computer system, and the computer systems communicate with each other by using a network. The computer system may be integrated into a terminal device, or may be a smartphone, a tablet computer, a notebook computer, or a desktop computer, but is not limited thereto.

It should be noted that a terminal device configured to perform steps of the P2P-based data processing method recorded in the embodiments of the present disclosure should have an interaction function, such as supporting a voice, a touch screen, or a keyboard.

As shown in FIG. 4, FIG. 4 is a schematic flowchart of a P2P-based data processing method according to an embodiment of the present disclosure. An embodiment of the present disclosure provides a P2P-based data processing method, including following steps.

S11. When a transaction operation of a subledger is triggered, transaction legality of the subledger is verified by using a general ledger.

S12. For a legal transaction, an amount of the subledger and a corresponding amount of the general ledger are updated, the subledger is enabled to save a current transaction record, and the general ledger is enabled to generate a latest transaction entry of the subledger and update a hash index table.

The legal transaction means that transaction data has a legal source and is correct. The hash index table is configured to record a correspondence between a hash value of a latest transaction record of the subledger and an address of the subledger. The general ledger is provided with a plurality of registers, each register stores an asset, and an amount of each type of asset is equal to a sum of amounts of the asset in latest transaction records of all subledgers in the general ledger.

In an embodiment, the index table is configured to realize an index function of the general ledger. Based on a principle of “one asset one address” (the one asset means one asset type, such as a crypto-asset), more asset types in a personal account book lead to more corresponding addresses. The address is an address of each of different asset types in an account book of the subledger. These addresses correspond to latest hash values of personal accounts in the general ledger. If the hash value is found, a personal account book from which an asset is sent is known.

It should be noted that a hash index becomes a part of a data structure of an account book address table. The hash index is used to determine an ownership of a record in the general ledger.

In an embodiment, the transaction operation includes an internal transaction operation between any two subledgers, and an external transaction operation between any subledger and an external account; and an interaction between any subledger and the general ledger is encrypted.

Optionally, when the transaction operation is the internal transaction operation, following operations are performed:

forwarding a transaction request reported by a first subledger to the general ledger, where the transaction request carries an asset type, an asset amount, and an address of a second subledger;

enabling the general ledger to verify transaction legality of the first subledger based on the transaction request;

for a legal transaction, keeping an amount of an asset in a register of the general ledger unchanged, and enabling the general ledger to generate new transaction entries of the first subledger and the second subledger; and

when two parties of the transaction confirm the transaction, updating the hash index table based on the transaction entries of the first subledger and the second subledger, and completing the transaction.

Specifically, for the legal transaction, the amount of the asset in the register of the general ledger keeps unchanged, the general ledger is enabled to generate the new transaction entries of the first subledger and the second subledger, the new transaction entry of the first subledger is sent to the first subledger to obtain a transaction confirmation instruction, the transaction confirmation instruction is forwarded to the second subledger to obtain a transaction confirmation instruction, a transaction entry and the hash index table that are stored in the general ledger are updated based on the transaction confirmation instructions of the two parties, and the transaction is completed. The generated transaction entry of the second subledger is processed in a similar way.

A sub-account is similar to a subledger of an account book. The subledger and the general ledger communicate with each other by using a network. Therefore, sending and receiving data through the Internet needs to be encrypted.

Optionally, when the transaction operation is the external transaction operation and an operation type is transfer-out, following operations are performed:

forwarding a transaction request reported by the subledger to the general ledger, where the transaction request carries an asset type, an asset amount, and an address of the external account;

enabling the general ledger to verify transaction legality of the subledger based on the transaction request; and

for a legal transaction, enabling the general ledger to generate a new subledger transaction entry, and when two parties of the transaction confirm the transaction, deducting, based on the new subledger transaction entry, an amount corresponding to the asset type in the register, and after verifying that the amount corresponding to the asset type in the register of the general ledger is equal to a sum of amounts corresponding to the asset type in latest transaction records of all subledgers in a latest transaction entry of the general ledger, updating the hash index table and completing the transaction.

Specifically, for the legal transaction, the general ledger is enabled to generate the new subledger transaction entry and send the new subledger transaction entry to the subledger to obtain a transaction confirmation instruction, the transaction confirmation instruction is forwarded to the external account of the general ledger, and a verification procedure is performed. After the verification is passed, the amount corresponding to the asset type in the register is deducted based on the confirmation instruction. After it is verified that the amount corresponding to the asset type in the register of the general ledger is equal to the sum of the amounts corresponding to the asset type in the latest transaction records of all the subledgers in the latest transaction entry of the general ledger, the hash index table is updated, and the transaction is completed.

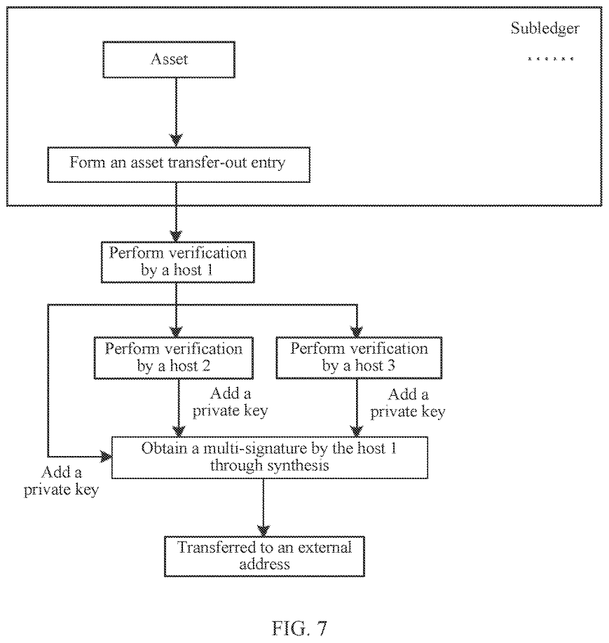

As shown in FIG. 5, FIG. 5 is a schematic flowchart of transferring out a crypto-asset by an individual according to an embodiment of the present disclosure. The crypto-asset is transferred to an address of any crypto-asset blockchain.

1. The individual sends an asset transfer-out instruction to the general ledger.

An external address of the general ledger for the crypto-asset is set by a system. Each asset has a register in the general ledger that corresponds to addresses of an account book of a cryptographic blockchain based on respective external addresses of the general ledger. The general ledger has a latest transaction record of an account (subledger) of the individual, indicating how many crypto-assets the individual has.

The individual signs a code of a crypto-asset to be transferred out, such as YBTC, in a general ledger system, the address of the any crypto-asset blockchain, and a latest record of a possessed asset by using a private key, and sends signed information to the general ledger. The general ledger can decrypt the signed information by using a public key.

2. The general ledger processes the subledger.

The general ledger verifies the crypto-asset (YBTC) of the account of the individual based on a record of the general ledger. If a verification result indicates that the crypto-asset is correct, the general ledger generates a new YBTC record, forwards the address and the data to the any crypto-asset blockchain, and sends the address and the data to the subledger in an encrypted manner.

3. The subledger confirms a latest index record, confirms the transfer-out, performs encryption, and then returns confirmation information to the general ledger.

4. The general ledger re-signs the content returned by the subledger, that is, starts multi-signature verification and transfer-out procedures.

5. After that, a quantity of transferred-out assets of a YBTC-specific external register of the general ledger is deducted, and a new YBTC record is generated for the subledger. The quantity of deducted assets is equal to that of assets transferred out by the subledger.

6. An index hash and an account book address index table are updated.

7. The updated YBTC record of the subledger is stored in the general ledger and forwarded to the subledger.

8. The subledger returns received information. After the returned information is received, the transfer-out information is stored in a transfer-out log.

It should be noted that a complete transfer-out record includes four parts: a transfer-out amount, a crypto-asset transfer-in address, a transfer-out signature, and a corresponding public key. This method corresponds to a crypto-asset standard.

This method has advantages in terms of an internal transfer speed, but affects speeds of encryption, decryption process, and verification processes. If only the general ledger performs verification, a data verification speed is very high.

Optionally, when the transaction operation is the external transaction operation and an operation type is transfer-in, following operations are performed:

enabling the general ledger to confirm an asset type and amount of a current transaction based on addresses of the subledger and the external account that are reported by the subledger, obtaining the asset type and amount in the address of the external account and transferring the obtained asset type and amount to the register, such that an asset amount of the register increases, generating a new subledger transaction entry and pushing the new subledger transaction entry to the subledger, updating the hash index table based on the new subledger transaction entry, and completing the transaction.

Specifically, the general ledger is enabled to generate a new subledger index, which is not a complete transaction record. The index is sent to the subledger to obtain a transaction confirmation instruction, and the transaction confirmation instruction is forwarded to the external account to obtain a confirmation instruction. An amount corresponding to the asset type in the register is deducted based on the transaction confirmation instruction. After it is verified that an amount corresponding to the asset type in the register of the general ledger is equal to a sum of amounts corresponding to the asset type in the latest transaction records of all the subledgers in the index table of the general ledger, the above steps 6 to 8 are performed to update the index table and complete the transaction.

Specifically:

6. An index hash and an account book address index table are updated.

7. The updated YBTC record of the subledger is stored in the general ledger and forwarded to the subledger.

8. The subledger returns received information. After the returned information is received, the transfer-out information is stored in a transfer-out log.

FIG. 6 is a schematic diagram of transferring in the crypto-asset by the individual according to an embodiment of the present disclosure. Only the subledger can initiate a transfer-in operation of the crypto-asset, and other transfer-in operations are invalid. It should be noted that the crypto-asset in the figure is converted into equivalent YBTC after being transferred to the system. The real crypto-asset remains in an account book of the crypto-asset. Therefore, security cannot be ensured if no multi-signature function is adopted.

FIG. 7 is a schematic flowchart of verifying transfer-out of the crypto-asset according to an embodiment of the present disclosure.

A transfer-out process has been described above, and a transfer-out verification process is described herein. The crypto-asset mentioned in the system is YBTC. The external account of the general ledger exists in an account of the crypto-as set blockchain, which is generated in the account book of the crypto-asset and is the same as a corresponding external account of the general ledger in the general ledger of the system. After the subledger sends a request to host 1, a verification procedure is preformed after successful confirmation. As shown in FIG. 7, this cluster has three hosts, forming a peer-to-peer cluster structure. Usually, only the host 1 works. First operations of the other two hosts are hot backup, and the other two hosts can take over the host 1 at any time. In addition, the other two hosts perform a multi-signature operation. In the embodiments of the present disclosure, it is assumed that a private key of host 2 is a combined private key, which is preset by the transfer-out subledger. If no signature is made, the system is always in a temporary storage state. A multi-signature design of an account book of the crypto-asset blockchain is 3-3. Therefore, if the subledger does not allow the transfer, the transfer cannot be executed. 24 hours later, the system automatically cancels the transfer.

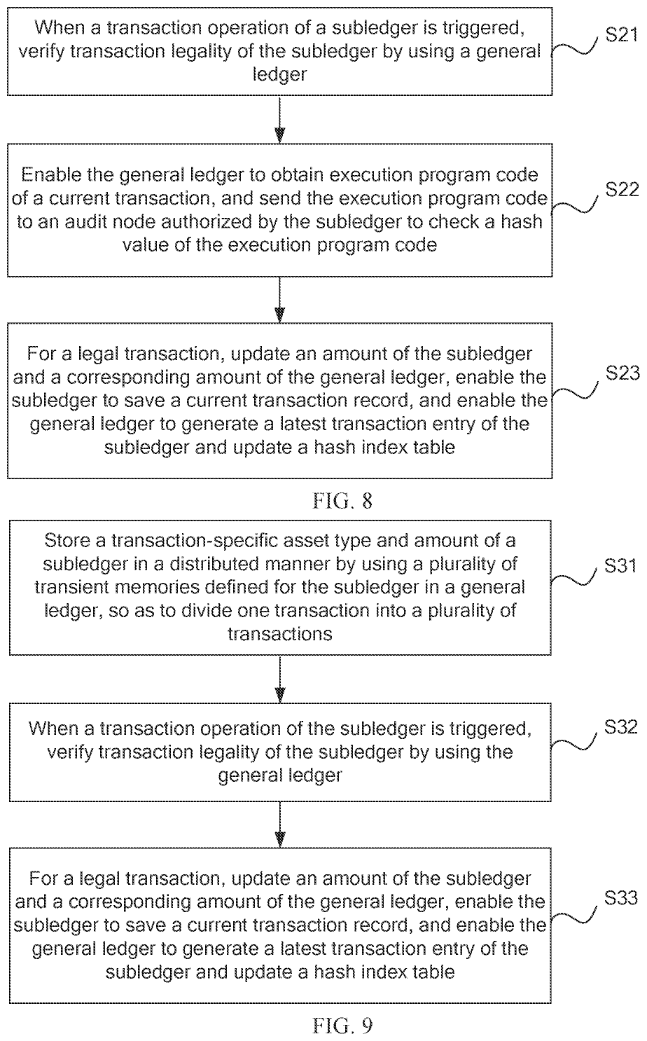

FIG. 8 is a schematic flowchart of a P2P-based data processing method according to an embodiment of the present disclosure. In an embodiment, after the general ledger verifies the transaction legality of the subledger, the P2P-based data processing method further includes a following step:

S22. The general ledger is enabled to obtain execution program code of the current transaction, and the execution program code is sent to an audit node authorized by the subledger to verify a hash value of the execution program code.

It should be noted that in all the above embodiments, except for private keys of a personal subledger (account book) and an external register, and a relevant calling program, all other codes are public and can be audited by any third party as the audit node. The subledger can specify any audit node for auditing. The auditing will slow down a transfer process. It is not recommended to add the audit node during an internal transfer, because only a machine, an input party, and an output party are required to perform verification. There is no third party for an external transfer. Therefore, it is necessary to introduce third-party audit and verification nodes. Input and output auditing results are used to verify whether hash values of the program code are the same. A third-party audit code may be used to verify a result.

As shown in FIG. 9, FIG. 9 is a schematic flowchart of a P2P-based data processing method according to an embodiment of the present disclosure. In an embodiment, before the transaction operation of the subledger is triggered, the P2P-based data processing method further includes a following step:

S31. A transaction-specific asset type and amount of the subledger are stored by using a plurality of temporary deposit accounts defined for the subledger in the general ledger, so as to divide one transaction into a plurality of transactions.

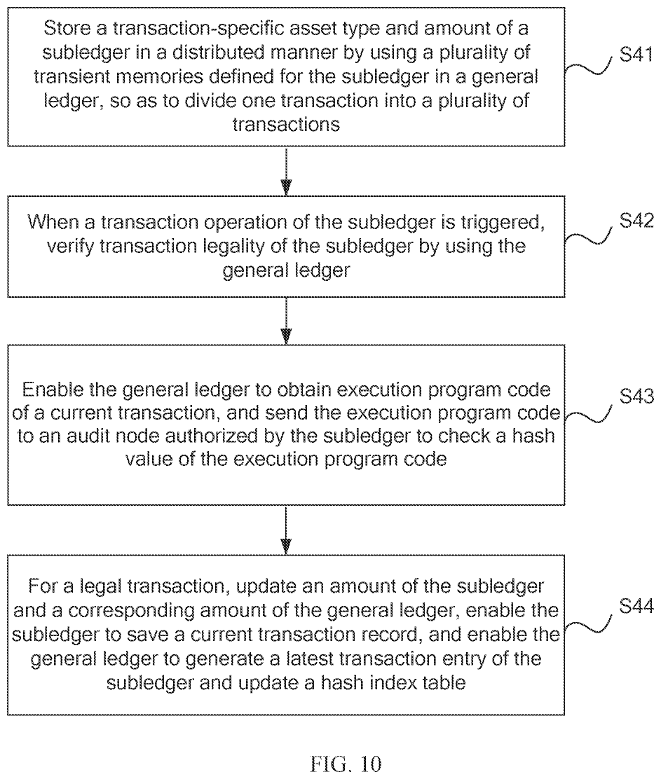

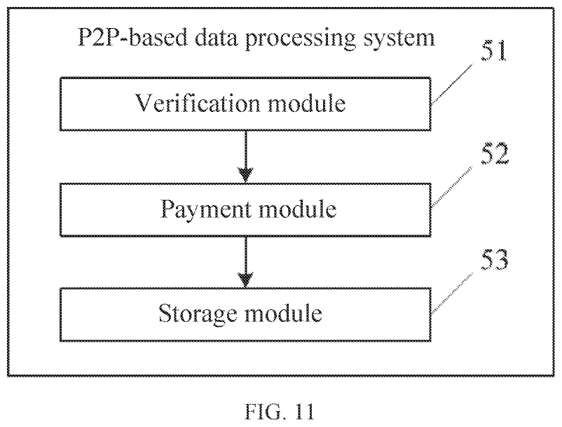

(Alternatively, as shown in FIG. 10, FIG. 10 is a schematic flowchart of a P2P-based data processing method according to an embodiment of the present disclosure. In an embodiment, before the transaction operation of the subledger is triggered, the P2P-based data processing method further includes a following step:

S41. A transaction-specific asset type and amount of the subledger are stored in a distributed manner by using a plurality of transient memories defined for the subledger in the general ledger, so as to divide one transaction into a plurality of transactions.)

The system may further include a user transient memory. One user can define a plurality of transient memories arbitrarily, for example, 10 transient memories, to mainly avoid dilation of the general ledger. The transient memory is used by a customer to disperse a large quantity of account books and then send dispersed account books. When small data is sent, if the data is forwarded twice, a real big account is hidden. If an account is public and can be queried by everyone, a counterparty knows a remitter and how many assets the remitter has. However, if only one record of the subledger in the general ledger has a hash value associated with a previous record, a counterparty cannot guess how many account books there are in your account. In this embodiment of the present disclosure, there is no charge when a user transfers an account book to himself/herself. There is a hidden-transfer setting in the subledger. Based on this setting, two transfers are performed automatically, and data, of the subledger, displayed on the general ledger is not exposed.

In an embodiment, latest data of the subledger can be found based on an address of the subledger and an index hash table. A query level is set in the setting. Like definitions of a stranger and an acquaintance on Facebook, four or five levels are defined. The four levels are: public, friends, specific friends, and yourself. In fact, there is also a level at which the general ledger queries all the subledgers, provided that the general ledger itself must be an audit node. A latest record of the subledger can be queried in the above four situations. The external register is public. A total quantity of external registers is displayed after “crypto-asset external register” is entered during search. For query of the subledger, such as “Li Ming, crypto-asset”, a latest record of the subledger can be found based on an index hash value associated with an address book of the subledger.

The general ledger and the subledger are associated by using a hash index, such that the general ledger has no account book, and the general ledger cannot find a historical transaction record. All transaction records are possessed personally, and the subledger determines whether to send the transaction records to relevant persons. A structure composed of the general ledger and the subledger is neither a blockchain structure nor a current bank accounting structure. The structure is much simpler than that of a centralized system, and avoids slow distributed authentication of a blockchain.

In the above embodiments of the present disclosure, uncentered control, namely, control decentralization, public account books, privacy protection, asset self-preservation, and the like are innovatively realized. In the embodiments of the present disclosure, a serial number may be used in a log ledger, which does not correspond to the hash value of the general ledger. Only the user can understand and verify his/her ledger, while others cannot see the ledger of the user, which ensures data privacy.

In the embodiments of the present disclosure, the log ledger is not disclosed, which can maximally protect privacy.

In the embodiments of the present disclosure, a transaction log ledger is composed of all transactions. In the embodiments of the present disclosure, one ledger page is formulated every 1 second, such that all nodes perform synchronization if they are willing. A has value of each ledger page can be calculated. Then a hash value of a minute-based ledger page is calculated based on hash values of all daily ledger pages, and is stored on a network chain to ensure that the account book is not tampered with. In the prior art, it generally takes at least three seconds to confirm one ledger page of the account book, and it is necessary to confirm 11 times, which generally takes about 30 seconds. This is a highest TPS of the blockchain if no network delay is considered, and it takes 1 to 2 minutes to complete an actual transaction. It may take half an hour to complete the traction if network congestion, packaging, and waiting are considered. A transaction of a transaction system in the embodiments of the present disclosure is completed upon confirmation by two parties. The transaction is completed in less than one second, which can reach and approach a TPS of the centralized system. In order to ensure security, all centralized transaction systems are structurally distributed. The present disclosure follows a centralized cluster method in a distributed structure, but achieves decentralized control, so as to fundamentally provide bookkeeping schemes for all blockchains and directed acyclic graphs and achieve a centralized TPS.

Referring to FIG. 11, based on a same inventive concept, an embodiment of the present disclosure provides a P2P-based data processing system, including:

verification module 51 configured to: when a transaction operation of a subledger is triggered, verify transaction legality of the subledger by using a general ledger;

payment module 52 configured to: for a legal transaction, update an amount of the subledger and a corresponding amount of the general ledger; and

storage module 53 configured to enable the subledger to save a current transaction record, and enable the general ledger to generate a latest transaction entry of the subledger and update a hash index table; where

the legal transaction means that transaction data has a legal source and is correct;

the hash index table is configured to record a correspondence between a hash value of a latest transaction record of the subledger and an address of the subledger; and

the general ledger is provided with a plurality of registers, each register stores one type of asset, and an amount of the asset is equal to a sum of amounts of the asset in latest transaction records of all subledgers in the general ledger.

In an embodiment, the transaction operation includes an internal transaction operation between any two subledgers, and an external transaction operation between any subledger and an external account; and an interaction between any subledger and the general ledger is encrypted.

In an embodiment, when the transaction operation is the internal transaction operation, following operations are performed:

forwarding a transaction request reported by a first subledger to the general ledger, where the transaction request carries an asset type, an asset amount, and an address of a second subledger;

enabling the general ledger to verify transaction legality of the first subledger based on the transaction request;

for a legal transaction, keeping an amount of an asset in a register of the general ledger unchanged, and enabling the general ledger to generate new transaction entries of the first subledger and the second subledger; and

when two parties of the transaction confirm the transaction, updating the hash index table based on the transaction entries of the first subledger and the second subledger, and completing the transaction.

In an embodiment, when the transaction operation is the external transaction operation and an operation type is transfer-out, following operations are performed:

forwarding a transaction request reported by the subledger to the general ledger, where the transaction request carries an asset type, an asset amount, and an address of the external account;

enabling the general ledger to verify transaction legality of the subledger based on the transaction request; and

for a legal transaction, enabling the general ledger to generate a new subledger transaction entry, and when two parties of the transaction confirm the transaction, deducting, based on the new subledger transaction entry, an amount corresponding to the asset type in the register, and after verifying that the amount corresponding to the asset type in the register of the general ledger is equal to a sum of amounts corresponding to the asset type in latest transaction records of all subledgers in a latest transaction entry of the general ledger, updating the hash index table and completing the transaction.

In an embodiment, when the transaction operation is the external transaction operation and an operation type is transfer-in, following operations are performed:

enabling the general ledger to confirm an asset type and amount of a current transaction based on addresses of the subledger and the external account that are reported by the subledger, obtaining the asset type and amount in the address of the external account and transferring the obtained asset type and amount to the register, such that an asset amount of the register increases, generating a new subledger transaction entry and pushing the new subledger transaction entry to the subledger, updating the hash index table based on the new subledger transaction entry, and completing the transaction.

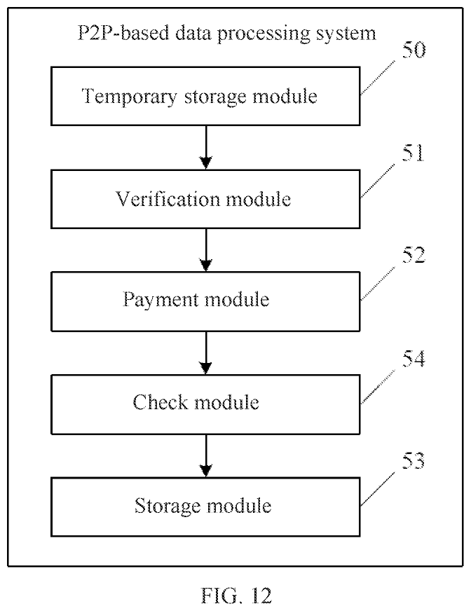

Referring to FIG. 12, in an embodiment, the P2P-based data processing system further includes:

check module 54 configured to enable the general ledger to obtain execution program code of the current transaction, and send the execution program code to an audit node authorized by the subledger to check a hash value of the execution program code.

With reference to FIG. 12, in an embodiment, the P2P-based data processing system further includes:

temporary storage module 50 configured to store a transaction-specific asset type and amount of the subledger by using a plurality of temporary deposit accounts defined for the subledger in the general ledger, so as to divide one transaction into a plurality of transactions.

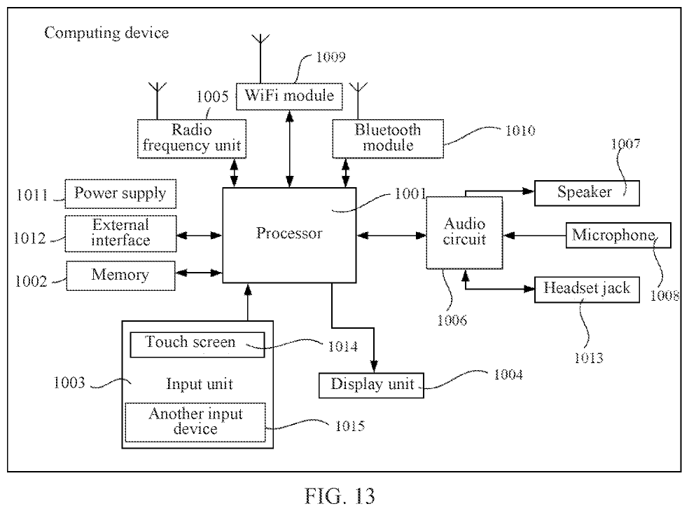

Based on a same inventive concept, an embodiment of the present disclosure provides a computing device. The computing device is a terminal device. Referring to FIG. 13, the computing device in this embodiment of the present disclosure includes at least one processor 1001 and memory 1002 connected to the at least one processor. In this embodiment of the present disclosure, a specific connection medium between the processor 1001 and the memory 1002 is not limited, for example, the processor 1001 and the memory 1002 may be connected by using a bus. The bus may be classified into an address bus, a data bus, a control bus, and the like.

In this embodiment of the present disclosure, the memory 1002 stores an instruction that can be executed by the at least one processor 1001. By executing the instruction stored in the memory 1002, the at least one processor 1001 can perform the steps included in the above-mentioned P2P-based data processing method.

The processor 1001 may be a general-purpose processor, for example, a central processing unit (CPU), a digital signal processor (DSP), an application-specific integrated circuit (ASIC), a field-programmable gate array (FPGA), another programmable logic device, a discrete gate or transistor logic device, or a discrete hardware component, and can implement or execute the methods, steps, and logical block diagrams disclosed in the embodiments of the present disclosure. The general-purpose processor may be a microprocessor, any conventional processor, or the like. The steps of the method disclosed in the embodiments of the present disclosure can be directly performed by a hardware processor, or by a combination of hardware in a processor and a software module.

As a non-volatile computer-readable storage medium, the memory 1002 can be configured to store a non-volatile software program, a non-volatile computer-executable program, and a module. The memory may include at least one type of storage medium, for example, may include a flash memory, a hard disk, a multimedia card, a card-type memory, a random access memory (RAM), a static random access memory (SRAM), a programmable read only memory (PROM), a read only memory (ROM), an electrically erasable programmable read-only memory (EEPROM), a magnetic memory, a magnetic disk, and an optical disk. The memory is any other medium that can be used to carry or store desired program code in a form of an instruction or a data structure and can be accessed by a computer, but is not limited thereto. The memory 1002 in this embodiment of the present disclosure may alternatively be a circuit or any other apparatus capable of realizing a storage function, and is configured to store a program instruction and/or data.

The processor 1001 is a control center of the computing device, connects to various parts of the computing device by using various interfaces and lines, and implements various functions and data processing of the computing device by running or executing the instruction stored in the memory 1002 and invoking data stored in the memory 1002, so as to perform overall monitoring on the computing device. Optionally, the processor 1001 may include one or more processing units. The processor 1001 may integrate an application processor and a modulation and demodulation processor. The application processor mainly processes an operating system, a user interface, an application program, and the like. The modulation and demodulation processor mainly processes wireless communication. It can be understood that the above modulation and demodulation processor may not be integrated into the processor 1001. In some embodiments, the processor 1001 and the memory 1002 may be implemented on a same chip. In some embodiments, the processor 1001 and the memory 1002 may alternatively be implemented on separate chips.

Further, the computing device in this embodiment of the present disclosure may further include input unit 1003, display unit 1004, radio frequency unit 1005, audio circuit 1006, speaker 1007, microphone 1008, WiFi module 1009, Bluetooth module 1010, power supply 1011, external interface 1012, headset jack 1013, and other components. Those skilled in the art can understand that FIG. 9 shows only an example of the computing device, and does not constitute a limitation to the computing device, and the computing device may include more or less components than those shown in the figure, a combination of some components, or different components.

The input unit 1003 can be configured to receive entered numbers or character information, and generate a key signal input related to user setting and function control of the computing device. For example, the input unit 1003 may include touch screen 1014 and another input device 1015. The touch screen 1014 can collect a touch operation performed by a user on or near the touch screen 1014 (such as an operation performed by the user on or near the touch screen 1014 by using any suitable object such as a finger, a joint, or a stylus), in other words, the touch screen 1014 can be configured to detect touch pressure, a touch input position, and a touch input area, and drive a corresponding connection apparatus according to a preset program. The touch screen 1014 can detect the touch operation performed by the user on the touch screen 1014, convert the touch operation into a touch signal, send the touch signal to the processor 1001 or send touch information of the touch operation to the processor 1001, and can receive and execute a command sent by the processor 1001. The touch information may include at least one of pressure size information and pressure duration information. The touch screen 1014 can provide an input interface and an output interface between the computing device and the user. In addition, the touch screen 1014 can be realized in resistive, capacitive, infrared, and surface acoustic wave forms. In addition to the touch screen 1014, the input unit 1003 may further include the another input device 1015. For example, the another input device 1015 may include but is not limited to one or more of a physical keyboard, a function key (such as a volume control key or a switch key), a trackball, a mouse, a joystick, and the like.

The display unit 1004 can be configured to display information input by or provided to the user and various menus of the computing device. Further, the touch screen 1014 can cover the display unit 1004. After detecting the touch operation on or near the touch screen 1014, the touch screen 1014 transmits the touch operation to the processor 1001 to determine pressure information of the touch operation. In this embodiment of the present disclosure, the touch screen 1014 and the display unit 1004 may be integrated into one component to realize input, output, and display functions of the computing device. For ease of description, this embodiment of the present disclosure provides a schematic explanation by using an example in which the touch screen 1014 is on behalf of a function set of the touch screen 1014 and the display unit 1004. Certainly, in some embodiments, the touch screen 1014 and the display unit 1004 may alternatively be used as two independent components.

When the display unit 1004 and a touch panel are superimposed on each other in a form of a layer to form the touch screen 1014, the display unit 1004 may be used as an input apparatus and an output apparatus, and when used as the output apparatus, the display unit 1004 can be configured to display an image, for example, to play various videos. The display unit 1004 may include at least one of a liquid crystal display (LCD), a thin film transistor liquid crystal display (TFT-LCD), an organic light emitting diode (OLED) display, an active matrix organic light emitting diode (AMOLED) display, an in-plane switching (IPS) display, a flexible display, a 3D display, and the like. Some of these displays can be configured as transparent to allow the user to view from the outside, which can be referred to as transparent displays. Based on a specific desired implementation, the computing device may include two or more display units (or other display apparatuses). For example, the computing device may include an external display unit (not shown in FIG. 13) and an internal display unit (not shown in FIG. 13).

The radio frequency unit 1005 can be configured to receive and transmit information or a signal during a call. Generally, a radio frequency circuit includes but is not limited to an antenna, at least one amplifier, a transceiver, a coupler, a low noise amplifier (LNA), a duplexer, and the like. In addition, the radio frequency unit 1005 can also communicate with a network device and other devices through wireless communication.

The audio circuit 1006, the speaker 1007, and the microphone 1008 can provide an audio interface between the user and the computing device. The audio circuit 1006 can transmit an electrical signal converted from received audio data to the speaker 1007, such that the speaker 1007 converts the electrical signal into a sound signal and outputs the sound signal. In addition, the microphone 1008 converts a collected sound signals into an electrical signal. The audio circuit 1006 receives the electrical signal, converts the received electrical signal into audio data, and then outputs the audio data to the processor 1001 for processing. Processed audio data is sent to another computing device through the radio frequency unit 1005, or the audio data is output to the memory 1002 for further processing. The audio circuit may alternatively include the headset jack 1013 configured to provide a connection interface between the audio circuit and a headset.

WiFi is a short-range wireless transmission technology. By using the WiFi module 1009, the computing device can help the user send and receive an e-mail, browse a web page, access a streaming medium, and the like. The WiFi module 1009 provides the user with wireless broadband Internet access. Although FIG. 13 shows the WiFi module 1009, it can be understood that the WiFi module 1009 is not a necessary component of the computing device, and may be omitted as required without changing the essence of the present disclosure.

Bluetooth is a short-range wireless communication technology. The Bluetooth technology can effectively simplify communication between mobile communication devices such as a palmtop computer, a laptop, and a mobile phone, and can also successfully simplify communication between these devices and the Internet. The computing device makes data transmission between the computing device and another device more rapid and efficient by using the Bluetooth module 1010, thereby broadening a road for wireless communication. The Bluetooth technology is an open solution that can realize wireless voice and data transmission. Although FIG. 13 shows the Bluetooth module 1010, it can be understood that the Bluetooth module 1010 is not a necessary component of the computing device, and may be omitted as required without changing the essence of the present disclosure.

The computing device may further include the power supply 1011 (such as a battery), which is configured to receive external power or supply power to various components within the computing device. Preferably, the power supply 1011 can be logically connected to the processor 1001 by using a power management system, so as to realize functions such as charging, discharging, and power consumption management by using the power management system.

The computing device may further include the external interface 1012. The external interface 1012 may include a standard micro USB interface or a multi-pin connector, and can be configured to connect the computing device to communicate with another device, or to connect a charger to charge the computing device.

Although not shown, a camera, a flash, and other possible functional modules may further be included in the computing device in this embodiment of the present discourse, and details are not described herein.

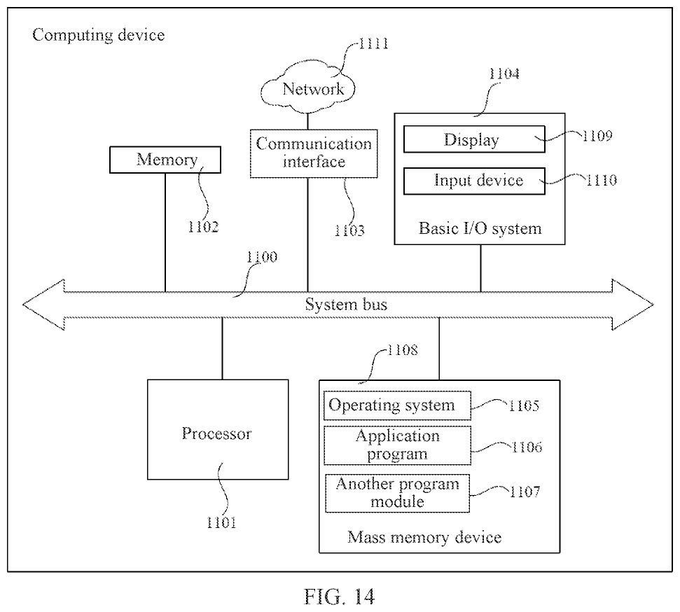

Based on a same inventive concept, an embodiment of the present disclosure provides a computing device. The computing device is a server. As shown in FIG. 14, the computing device in this embodiment of the present disclosure includes at least one processor 1101, memory 1102 connected to the at least one processor 1101, and communication interface 1103. In this embodiment of the present disclosure, a specific connection medium between the processor 1101 and the memory 1102 is not limited. For example, the processor 1101 and the memory 1102 are connected by using bus 1100 in FIG. 14. The bus 1100 is shown in a thick line in FIG. 14. A connection mode between other components is only for schematic illustration and is not limited thereto. The bus 1100 may be classified into an address bus, a data bus, a control bus, and the like. For ease of representation, only one thick line is used to represent the bus in FIG. 14, but this does not mean that there is only one bus or only one type of bus.

In this embodiment of the present application, the memory 1102 stores an instruction that can be executed by the at least one processor 1101. By executing the instruction stored in the memory 1102, the at least one processor 1101 can perform the steps included in the above-mentioned P2P-based data processing method.

The processor 1101 is a control center of the computing device, connects to various parts of the computing device by using various interfaces and lines, and implements various functions and data processing of the computing device by running or executing the instruction stored in the memory 1102 and invoking data stored in the memory 1102, so as to perform overall monitoring on the computing device. Optionally, the processor 1101 may include one or more processing units. The processor 1101 may integrate an application processor and a modulation and demodulation processor. The processor 1101 mainly processes an operating system, a user interface, an application program, and the like. The modulation and demodulation processor mainly processes wireless communication. It can be understood that the above modulation and demodulation processor may not be integrated into the processor 1101. In some embodiments, the processor 1101 and the memory 1102 may be implemented on a same chip. In some embodiments, the processor 1101 and the memory 1102 may alternatively be implemented on separate chips.

The processor 1101 may be a general-purpose processor, for example, a CPU, a DSP, an ASIC, an FPGA, another programmable logic device, a discrete gate or transistor logic device, or a discrete hardware component, and can implement or execute the methods, steps, and logical block diagrams disclosed in the embodiments of the present disclosure. The general-purpose processor may be a microprocessor, any conventional processor, or the like. The steps of the method disclosed in the embodiments of the present disclosure can be directly performed by a hardware processor, or by a combination of hardware in a processor and a software module.

As a non-volatile computer-readable storage medium, the memory 1102 can be configured to store a non-volatile software program, a non-volatile computer-executable program, and a module. The memory 1102 may include at least one type of storage medium, for example, may include a flash memory, a hard disk, a multimedia card, a card-type memory, a RAM, an SRAM, a PROM, a ROM, an EEPROM, a magnetic memory, a magnetic disk, and an optical disk. The memory 1102 is any other medium that can be used to carry or store desired program code in a form of an instruction or a data structure and can be accessed by a computer, but is not limited thereto. The memory 1102 in this embodiment of the present disclosure may alternatively be a circuit or any other apparatus capable of realizing a storage function, and is configured to store a program instruction and/or data.

The communication interface 1103 is a transmission interface that can be used for communication. For example, data can be received or transmitted through the communication interface 1103.

Still referring to FIG. 14, the computing device further includes basic input/output system (I/O system) 1104 that helps information transmission between various devices in the computing device, and mass memory device 1108 for storing operating system 1105, application program 1106, and another program module 1107.

The basic I/O system 1104 includes display 1109 for displaying information and input device 1110 such as a mouse and a keyboard for a user to input information. Both the display 1109 and the input device 1110 are connected to the processor 1101 through the basic I/O system 1104 connected to the system bus 1100. The basic I/O system 1104 may further include an I/O controller for receiving and processing inputs from a plurality of other devices such as the keyboard, the mouse, and an electronic stylus. Similarly, the I/O controller further provides an output to the display, a printer, or another type of output device.

The mass memory device is connected to the processor 1101 through a mass memory controller (not shown) connected to the system bus 1100. The mass memory device 1108 and its associated computer-readable medium provide a non-volatile memory for the server. In other words, the mass memory device 1108 may include the computer-readable medium (not shown) such as a hard disk or a CD-ROM drive.

According to various embodiments of the present disclosure, the computing device may be further connected to a remote computer on a network through the Internet or another network. That is, the computing device may be connected to network 1111 through the communication interface 1103 connected to the system bus 1100, or may be connected to another type of network or remote computer system (not shown) through the communication interface 1103.

Based on a same inventive concept, an embodiment of the present disclosure provides a storage medium. The storage medium may be a computer-readable storage medium, and the storage medium stores a computer instruction. When the computer instruction runs on a computer, the computer is enabled to execute the steps included in the above-described P2P-based data processing method.

Based on a same inventive concept, an embodiment of the present disclosure provides a chip system. The chip system includes a processor, and may also include a memory, and is configured to implement the steps included in the above-described P2P-based data processing method. The chip system may be constituted by a chip, or may alternatively contain a chip and another discrete device.

In some possible implementations, various aspects of the data processing method provided in the embodiments of the present disclosure may alternatively be implemented in a form of a program product, which includes program code. When the program product runs on a computer, the program code is used to enable the computer to perform the steps included in the above-described P2P-based data processing method according to various exemplary implementations of the present disclosure.

Those skilled in the art should understand that the embodiments of the present disclosure may be provided as a method, an apparatus, a system, or a computer program product. Therefore, the present disclosure may use a form of hardware only embodiments, software only embodiments, or embodiments with a combination of software and hardware. Moreover, the present disclosure may be in a form of a computer program product that is implemented on one or more computer-usable storage media (including but not limited to a magnetic disk memory, a CD-ROM, an optical memory, and the like) that include computer-usable program code.

Apparently, persons skilled in the art can make various modifications and variations to the present disclosure without departing from the spirit and scope of the present disclosure. The present disclosure is intended to cover these modifications and variations provided that they fall within the scope of the claims of the present application and their equivalent technologies.

1. A point-to-point (P2P)-based data processing method, comprising:
when a transaction operation of a subledger is triggered, verifying transaction legality of the subledger by using a general ledger; and
for a legal transaction, updating an amount of the subledger and a corresponding amount of the general ledger, enabling the subledger to save a current transaction record, and enabling the general ledger to generate a latest transaction entry of the subledger and update a hash index table; wherein
the legal transaction means that transaction data has a legal source and is correct;
the hash index table is configured to record a correspondence between a hash value of a latest transaction record of the subledger and an address of the subledger;
the general ledger is provided with a plurality of registers, each register stores one type of asset, and an amount of the asset is equal to a sum of amounts of the asset in latest transaction records of all subledgers in the general ledger; and
the transaction operation comprises an internal transaction operation between any two subledgers, and when the transaction operation is the internal transaction operation, following operations are performed:
forwarding a transaction request reported by a first subledger to the general ledger, wherein the transaction request carries an asset type, an asset amount, and an address of a second subledger;
enabling the general ledger to verify transaction legality of the first subledger based on the transaction request;
for a legal transaction, keeping an amount of an asset in a register of the general ledger unchanged, and enabling the general ledger to generate new transaction entries of the first subledger and the second subledger; and
when two parties of the transaction confirm the transaction, updating the hash index table based on the transaction entries of the first subledger and the second subledger, and completing the transaction.

2. The method according to claim 1, wherein the transaction operation further comprises an external transaction operation between any subledger and an external account; and an interaction between any subledger and the general ledger is encrypted.

3. The method according to claim 2, wherein when the transaction operation is the external transaction operation and an operation type is transfer-out, following operations are performed:
forwarding a transaction request reported by the subledger to the general ledger, wherein the transaction request carries an asset type, an asset amount, and an address of the external account;
enabling the general ledger to verify transaction legality of the subledger based on the transaction request; and
for a legal transaction, enabling the general ledger to generate a new subledger transaction entry, and when two parties of the transaction confirm the transaction, deducting, based on the new subledger transaction entry, an amount corresponding to the asset type in the register, and after verifying that an amount corresponding to the asset type in the register of the general ledger is equal to a sum of amounts corresponding to the asset type in latest transaction records of all subledgers in a latest transaction entry of the general ledger, updating the hash index table and completing the transaction.

4. The method according to claim 2, wherein when the transaction operation is the external transaction operation and an operation type is transfer-in, following operations are performed:
enabling the general ledger to confirm an asset type and amount of a current transaction based on addresses of the subledger and the external account that are reported by the subledger, obtaining the asset type and amount in the address of the external account and transferring the obtained asset type and amount to the register, such that an asset amount of the register increases, generating a new subledger transaction entry and pushing the new subledger transaction entry to the subledger, updating the hash index table based on the new subledger transaction entry, and completing the transaction.

5. The method according to claim 1, wherein after the verifying transaction legality of the subledger by using a general ledger, further comprising:
enabling the general ledger to obtain execution program code of the current transaction, and sending the execution program code to an audit node authorized by the subledger to verify a hash value of the execution program code.

6. The method according to claim 1, wherein before the transaction operation of the subledger is triggered, further comprising:
storing a transaction-specific asset type and amount of the subledger by using a plurality of temporary deposit accounts defined for the subledger in the general ledger, so as to divide one transaction into a plurality of transactions.

7. A P2P-based data processing system, comprising:
a verification module configured to: when a transaction operation of a subledger is triggered, verify transaction legality of the subledger by using a general ledger;
a payment module configured to: for a legal transaction, update an amount of the subledger and a corresponding amount of the general ledger; and
a storage module configured to enable the subledger to save a current transaction record, and enable the general ledger to generate a latest transaction entry of the subledger and update a hash index table; wherein
the legal transaction means that transaction data has a legal source and is correct;
the hash index table is configured to record a correspondence between a hash value of a latest transaction record of the subledger and an address of the subledger;
the general ledger is provided with a plurality of registers, each register stores one type of asset, and an amount of the asset is equal to a sum of amounts of the asset in latest transaction records of all subledgers in the general ledger; and
the transaction operation comprises an internal transaction operation between any two subledgers, and when the transaction operation is the internal transaction operation, following operations are performed:
forwarding a transaction request reported by a first subledger to the general ledger, wherein the transaction request carries an asset type, an asset amount, and an address of a second subledger;
enabling the general ledger to verify transaction legality of the first subledger based on the transaction request;
for a legal transaction, keeping an amount of an asset in a register of the general ledger unchanged, and enabling the general ledger to generate new transaction entries of the first subledger and the second subledger; and
when two parties of the transaction confirm the transaction, updating the hash index table based on the transaction entries of the first subledger and the second subledger, and completing the transaction.

8. A computing device, comprising a memory, a processor, and a computer program stored in the memory and executable on the processor, wherein the processor executes the computer program to implement the steps comprised in the P2P-based data processing method according to claim 1.

9. A storage medium, wherein the storage medium stores a computer-executable instruction, and the computer-executable instruction is configured to enable a computer to perform the steps comprised in the P2P-based data processing method according to claim 1.

10. The method according to claim 2, wherein after the verifying transaction legality of the subledger by using a general ledger, further comprising:
enabling the general ledger to obtain execution program code of the current transaction, and sending the execution program code to an audit node authorized by the subledger to verify a hash value of the execution program code.

11. The method according to claim 3, wherein after the verifying transaction legality of the subledger by using a general ledger, further comprising:
enabling the general ledger to obtain execution program code of the current transaction, and sending the execution program code to an audit node authorized by the subledger to verify a hash value of the execution program code.

12. The method according to claim 4, wherein after the verifying transaction legality of the subledger by using a general ledger, further comprising:
enabling the general ledger to obtain execution program code of the current transaction, and sending the execution program code to an audit node authorized by the subledger to verify a hash value of the execution program code.

13. The method according to claim 2, wherein before the transaction operation of the subledger is triggered, further comprising:
storing a transaction-specific asset type and amount of the subledger by using a plurality of temporary deposit accounts defined for the subledger in the general ledger, so as to divide one transaction into a plurality of transactions.

14. The method according to claim 3, wherein before the transaction operation of the subledger is triggered, further comprising:
storing a transaction-specific asset type and amount of the subledger by using a plurality of temporary deposit accounts defined for the subledger in the general ledger, so as to divide one transaction into a plurality of transactions.

15. A computing device, comprising a memory, a processor, and a computer program stored in the memory and executable on the processor, wherein the processor executes the computer program to implement the steps comprised in the P2P-based data processing method according to claim 2.

16. A computing device, comprising a memory, a processor, and a computer program stored in the memory and executable on the processor, wherein the processor executes the computer program to implement the steps comprised in the P2P-based data processing method according to claim 3.

17. A computing device, comprising a memory, a processor, and a computer program stored in the memory and executable on the processor, wherein the processor executes the computer program to implement the steps comprised in the P2P-based data processing method according to claim 4.

18. A storage medium, wherein the storage medium stores a computer-executable instruction, and the computer-executable instruction is configured to enable a computer to perform the steps comprised in the P2P-based data processing method according to claim 2.

19. A storage medium, wherein the storage medium stores a computer-executable instruction, and the computer-executable instruction is configured to enable a computer to perform the steps comprised in the P2P-based data processing method according to claim 3.

20. A storage medium, wherein the storage medium stores a computer-executable instruction, and the computer-executable instruction is configured to enable a computer to perform the steps comprised in the P2P-based data processing method according to claim 4.
